(19) United States
(12) Patent Application Publication
(10) Pub. No.: US 2025/0269673 A1
(43) Pub. Date: Aug. 28, 2025

(54) LIQUID DISCHARGE HEAD AND LIQUID DISCHARGE APPARATUS

(71) Applicant: Yuuki MIZUTANI, Kanagawa (JP)

(72) Inventor: Yuuki MIZUTANI, Kanagawa (JP)

(21) Appl. No.: 19/010,207

(22) Filed: Jan. 6, 2025

(30) Foreign Application Priority Data
Feb. 28, 2024 (JP) 2024-028582

(51) Int. Cl. B41J 29/377; B41J 2/14; B41J 11/00

(52) U.S. Cl. CPC B41J 29/377; B41J 2/14201; B41J 11/002; B41J 11/007; B41J 2202/08

(57) ABSTRACT

A liquid discharge head includes a first member and a second member whose linear-expansion coefficients are different from each other, the first member and the second member disposed in contact with each other, and a coolant duct passing through an inside of the second member, the coolant duct including a first projecting part and a second projecting part. The first projecting part and the second projecting part project in a first direction different from a second direction in which a coolant is sent in the coolant duct. One of the first projecting part and the second projecting part is disposed upstream from a contact surface of the first member and the second member in the second direction, and the other one of the first projecting part and the second projecting part is disposed downstream from the contact surface in the second direction.

### CROSS-REFERENCE TO RELATED APPLICATION

This patent application is based on and claims priority pursuant to 35 U.S.C. § 119(a) to Japanese Patent Application No. 2024-028582, filed on Feb. 28, 2024, in the Japan Patent Office, the entire disclosure of which is hereby incorporated by reference herein.

### BACKGROUND

### Technical Field

The present disclosure relates to a liquid discharge head and a liquid discharge apparatus.

### Background Art

In liquid discharge heads, for example, a piezoelectric actuator is driven to build up pressure in an individual liquid chamber, and the ink inside such an individual liquid chamber is discharged from a nozzle. In so doing, the piezoelectric element inside the piezoelectric actuator liberates heat, and the temperature inside the liquid discharge head increases.

By contrast, in some liquid discharge heads, a coolant duct through which cooling water runs as coolant is arranged to prevent the temperature from increasing.

### SUMMARY

The present disclosure described herein provides a liquid discharge head including a first member and a second member whose linear-expansion coefficients are different from each other, the first member and the second member disposed in contact with each other, and a coolant duct passing through an inside of the second member, the coolant duct including a first projecting part and a second projecting part. The first projecting part and the second projecting part project in a first direction different from a second direction in which a coolant is sent in the coolant duct. One of the first projecting part and the second projecting part is disposed upstream from a contact surface of the first member and the second member in the second direction, and the other one of the first projecting part and the second projecting part is disposed downstream from the contact surface in the second direction.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a schematic diagram of an inkjet recording apparatus provided with a liquid discharge head.

FIG. 2 is a plan view of an inkjet recording apparatus.

FIG. 3 is an exploded perspective view of a head body provided for the liquid discharge head of FIG. 1, illustrating its structure in a simplified manner.

FIG. 4 is a plan view of the components of a head body from the face of a nozzle plate.

FIG. 5 is a plan view of the components of a head body from a multi-layer piezoelectric element side.

FIG. 6 is a lateral sectional view of a liquid discharge head along a line A-A′ in FIG. 3.

FIG. 7 is a sectional view of a liquid discharge head along a line B-B′ in FIG. 6.

FIG. 8A is a perspective view of a liquid discharge head.

FIG. 8B is a sectional view of the liquid discharge head along E-E′ in FIG. 8A.

FIG. 8C is a schematic plan view of a temperature-control liquid duct.

FIG. 9 is a sectional view of a liquid discharge head according to a modification.

FIG. 10 is a sectional view of a liquid discharge head according to a modification.

FIG. 11 is a sectional view of a liquid discharge head according to a modification.

FIG. 12 is a schematic diagram illustrating a structure of a liquid discharge apparatus.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Embodiments of the present disclosure are described below with reference to the drawings. In the drawings, like reference signs denote like elements, and overlapping description may be simplified or omitted as appropriate.

Firstly, a basic configuration of an inkjet recording apparatus or a liquid discharge apparatus is described below.

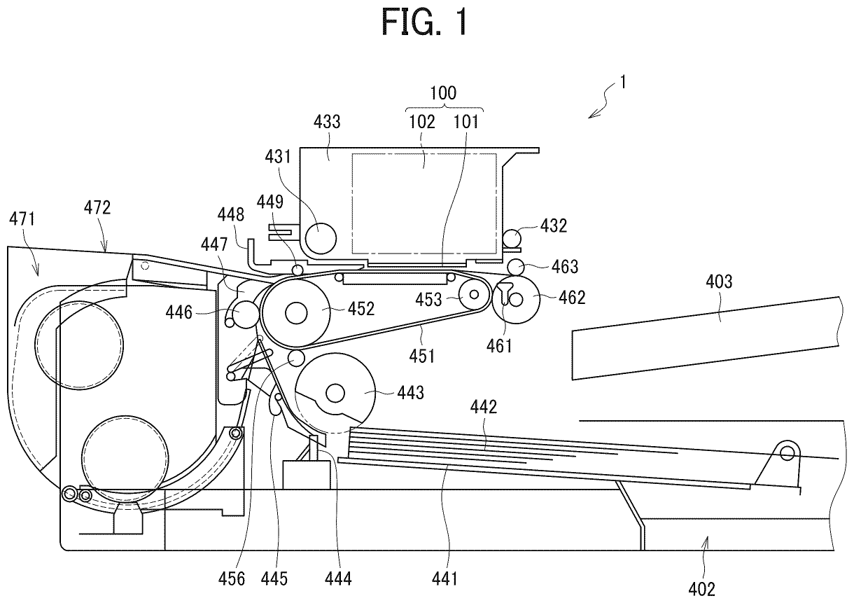

FIG. 1 is a schematic diagram of an inkjet recording apparatus 1.

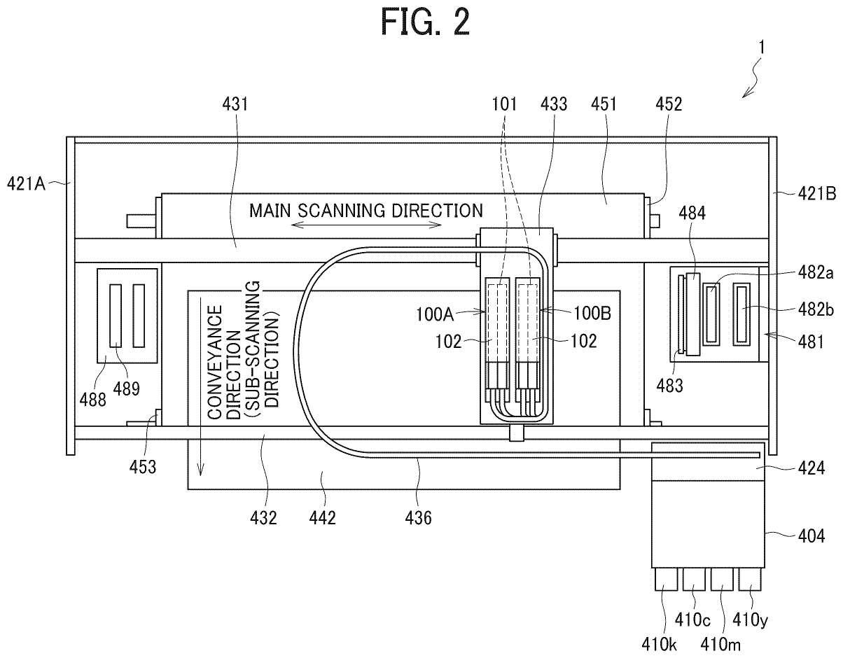

FIG. 2 is a schematic plan view of the inkjet recording apparatus 1.

The inkjet recording apparatus 1 is a serial inkjet recording apparatus, and includes a main guide rod 431 and a sub-guide rod 432 to hold a carriage 433. The main guide rod 431 and the sub-guide rod 432 are laterally bridged between a left side plate 421A and a right side plate 421B, and the carriage 433 reciprocates in a main scanning direction indicated by an arrow in FIG. 2. The carriage 433 is provided with a pair of liquid discharge heads 100A and 100B in which a head body 101 and a head tank 102 are integrated. The head tank is a sub-tank that supplies the head body 101 with liquid such as ink. The head body 101 includes a row of nozzles 2A (discharge orifices). The nozzles 2A are arranged in the sub-scanning direction that is parallel to the longitudinal direction of the row of nozzles 2A and the liquid discharge head 100 and is perpendicular to the main scanning direction. The pair of liquid discharge heads 100A and 100B are arranged with the direction in which liquid is discharged or the direction in which the nozzles 2A extend, which is parallel to the direction orthogonal to the main scanning direction and the sub-scanning direction, being downward in the vertical direction. However, it is not necessary for such a direction to be strictly vertical. The liquid discharge head 100A or the liquid discharge head 100B may be referred to simply as a liquid discharge head 100 in the following description.

Each of the pair of liquid discharge heads 100A and 100B includes two rows of nozzles. The head body 101 of the liquid discharge head 100A uses one of the pair of rows of nozzles 2A to discharge ink droplets of black (K), and uses the other one of the pair of rows of nozzles 2A to discharge ink droplets of cyan (C). The head body 101 of the liquid discharge head 100B uses one of the pair of rows of nozzles 2A to discharge ink droplets of magenta (M), and uses the other one of the pair of rows of nozzles 2A to discharge ink droplets of yellow (Y).

In the present embodiment, the inkjet recording apparatus 1 uses two liquid discharge heads to discharge ink droplets of four colors. In some embodiments, four rows of nozzles may be arrayed in a single liquid discharge head to discharge ink of four colors. When the liquid discharge heads 100A and 100B are formed as a single integrated unit, the head body 101 and the head tank 102 are fixed to each other by, for example, a fastening or adhesive member, directly or through, for example, a filtering member. Alternatively, the head body 101 and the head tank 102 are interconnected through, for example, a tube.

Main tanks 410k, 410c, 410m, and 410y that serve as liquid cartridges of four colors are detachably attached to a cartridge holder 404 provided for the housing of the inkjet recording apparatus 1. A liquid feed unit 424 that includes a liquid feed pump 438c feeds the head tanks 102 of the liquid discharge heads 100A and the liquid discharge head 100B with ink of the four colors through supply tubes 436 of the four colors from the main tanks 410k, 410c, 410m, and 410y.

The inkjet recording apparatus 1 includes a sheet feeder that feeds recording sheets 442, which are an example of recording materials and stacked on a sheet loading unit 441 of a sheet tray 402. The sheet feeder includes, for example, a sheet feed roller 443 and a separation pad 444 that is arranged opposite the sheet feed roller 443. The sheet feed roller 443 and the separation pad 444 separate and feed the recording sheets 442 on a one-by-one basis from the sheet loading unit 441.

The inkjet recording apparatus 1 further includes a guide 445, a counter roller 446, a conveyance guide 447, and a pressing member 448 including a leading-end pressure roller 449, to convey and guide the recording sheet 442 fed by the sheet feeder. The inkjet recording apparatus 1 further includes a conveyance belt 451 that is an example of a sheet conveyor to attract the recording sheet 442 and convey the recording sheet 442 at a position opposite the head body 101 of the liquid discharge head 100.

The conveyance belt 451 is an endless belt stretched between the conveyance roller 452 and the tension roller 453 and goes around in the conveyance direction of the belt. In other words, the conveyance belt 451 goes around in the sub-scanning direction. The conveyance belt 451 is an electrostatic conveyance belt charged by a charging roller 456 that is an example of a charger. However, in some embodiments, the conveyance belt 451 may be a conveyance belt to attract the recording sheet 442 by air suction. Alternatively, the conveyor is not limited to the conveyance belt and may be, for example, a conveyance roller.

At a position downstream from the tension roller 453 around which the conveyance belt 451 is looped, a stripper finger 461 that separates the recording sheet 442 from the conveyance belt 451 and a pair of output rollers 462 and 463 are arranged. Moreover, an output tray 403 is arranged under the output roller 462. A double-sided unit 471 is attached to the rear side of the housing of the inkjet recording apparatus 1 in a detachable manner. The double-sided unit 471 takes in the recording sheet 442 returned by the reverse-directional rotation of the conveyance belt 451, and reverses the recording sheet 442. Then, the recording sheet 442 is fed again between the counter roller 446 and the conveyance belt 451. Moreover, the upper side of the double-sided unit 471 serves as a manual sheet feeding tray 472. A maintenance-and-recovery unit 481 is arranged in a non-printing area at one side in the main scanning direction of the carriage 433 to maintain and recover the state of the nozzles of the head bodies 101 of the liquid discharge heads 100A and 100B.

The maintenance-and-recovery unit 481 includes caps 482a and 482b that cap the surfaces of nozzle plates of the head bodies 101. The maintenance-and-recovery unit 481 includes a blade 483 to wipe the face of the nozzle plate 2. The maintenance-and-recovery unit 481 further includes, for example, a dummy discharge receptacle 484 to receive ink discharged in dummy discharge in which ink not contributing to image formation is discharged to discharge thickened ink. In a non-printing area at the other end in the main scanning direction of the carriage 433, a dummy discharge receptacle 488 to receive ink discharged by dummy discharge during image formation is arranged. The dummy discharge receptacle 488 includes, for example, openings 489 along the direction in which nozzles 2A of the head body 101 are arrayed in a row.

In the inkjet recording apparatus 1 according to the present embodiment, the recording sheets 442 are separated on a one-piece-by-one-piece basis from the sheet tray 402, and the recording sheet 442 is fed in a substantially vertically upward direction. Then, the recording sheet 442 is guided along the guide 445, and is conveyed upon being interposed between the conveyance belt 451 and the counter roller 446. Then, the front end of the recording sheet 442 is guided by the conveyance guide 437 and is pressed against the conveyance belt 451 by the leading-end pressure roller 449. Accordingly, the direction of conveyance of the recording sheet 442 is turned by approximately 90 degrees. When the recording sheet 442 is fed onto the conveyance belt 451 charged by the charging roller 456, the recording sheet 442 is attracted onto the conveyance belt 451 and conveyed in the sub-scanning direction by the circulating movement of the conveyance belt 451. By driving the head bodies 101 of the liquid discharge heads 100A and 100B in response to image signals while moving the carriage 433, ink is discharged onto the stopped recording sheet 442 to record one line of a desired image. After a predetermined amount of the recording sheet 442 is fed, the image forming operation for the next line is conducted. When a recording end signal or a signal indicating that the rear end of the recording sheet 442 has reached the recording area is received, the recording operation is terminated, and the recording sheet 442 is ejected to the output tray 403.

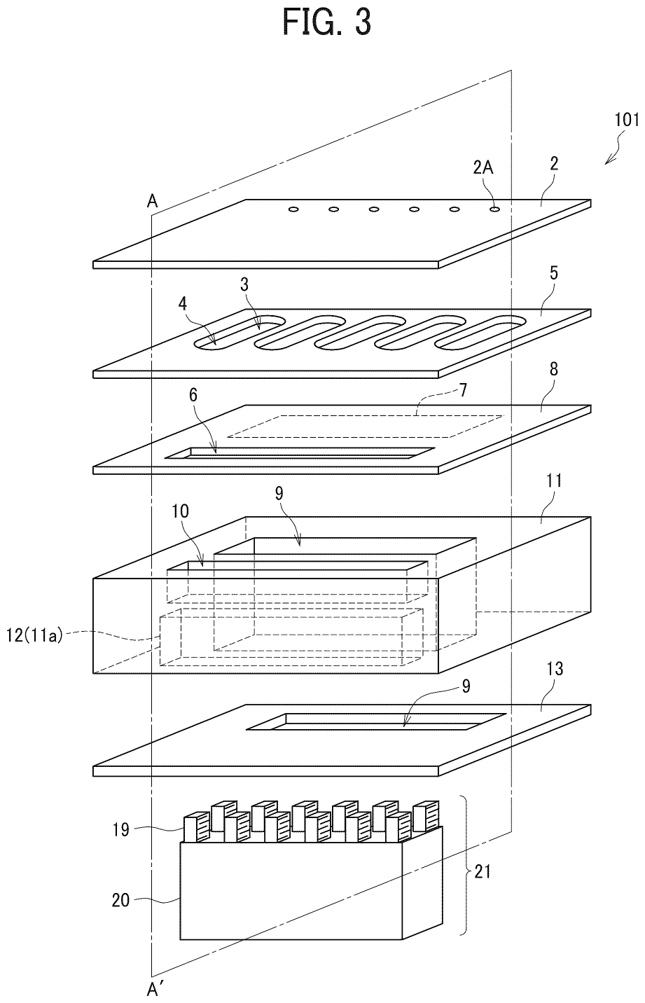

FIG. 3 is an exploded perspective view of the head body 101, illustrating its structure in a simplified manner.

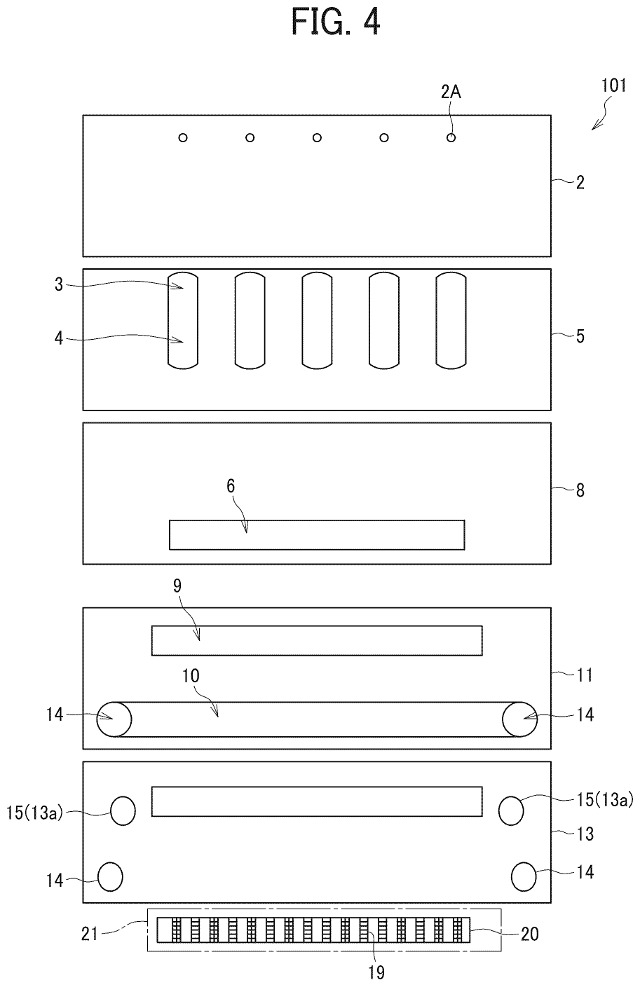

FIG. 4 is an exploded plan view of the plate-like components of the head body 101 from the face of the nozzle plate 2.

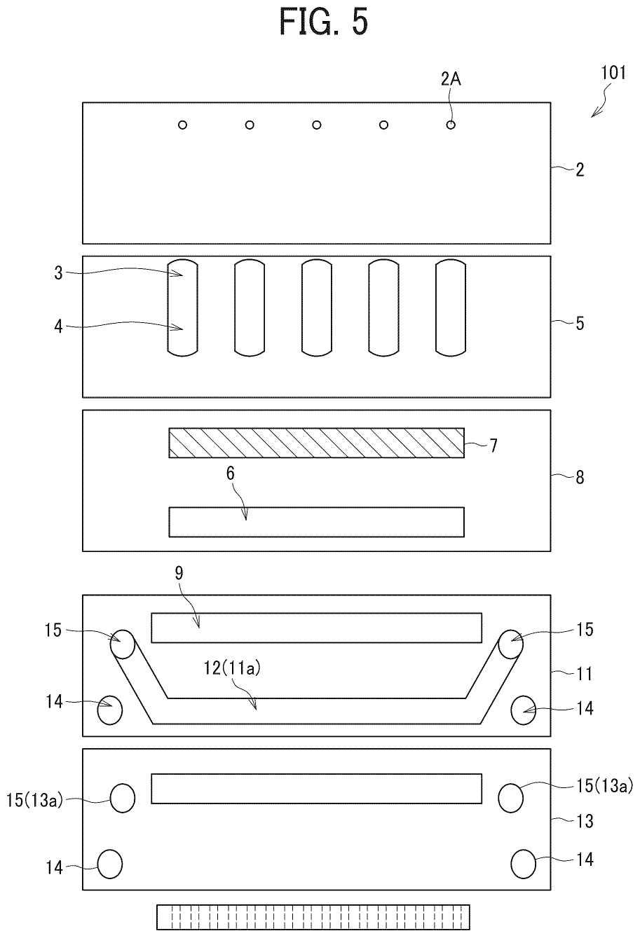

FIG. 5 is an exploded plan view of the plate-like components of the head body 101 from a multi-layer piezoelectric element side.

FIG. 3 to FIG. 5 are diagrams each of which illustrates one of the two rows of nozzles provided for the head body 101.

In those drawings, the nozzles 2A that are an example of a plurality of discharge orifices are formed on the nozzle plate 2 that is an example of a discharge-orifice forming member. The nozzle plate 2 is made of, for example, a plate of stainless steel. The processing precision of the slits (through holes) that serve as the nozzles 2A has a great influence on the ink discharge characteristics of the head body 101. In order to reduce the variation in dimensional accuracy among the nozzles 2A, it is necessary to process the slits on the nozzle plate 2 with a high degree of precision. In order to achieve such a high degree of precision, the slits on the nozzle plate 2 are formed by, for example, presswork, laser processing, electroforming with nickel (Ni).

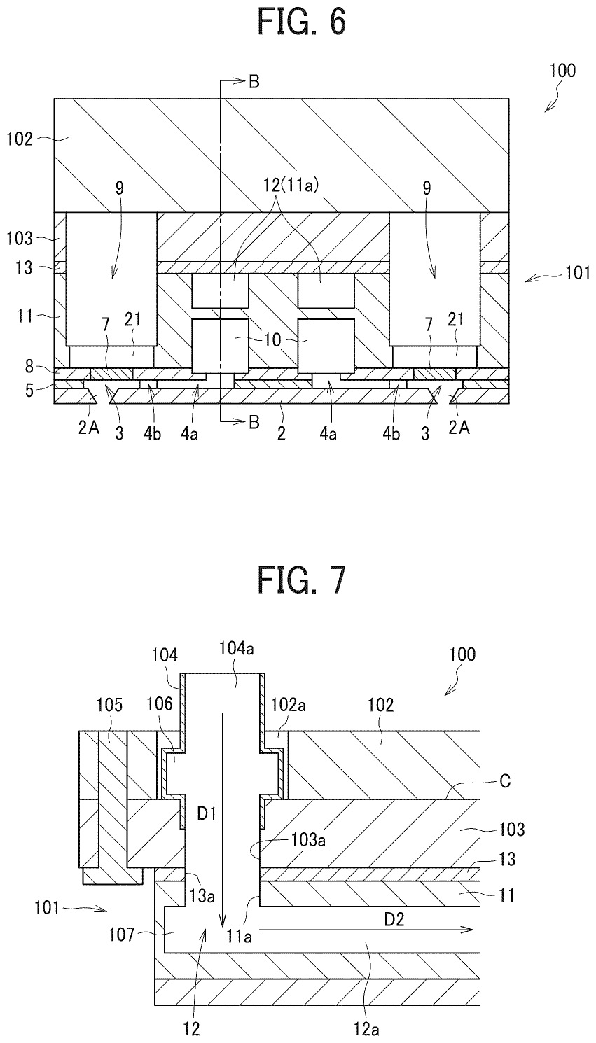

The side faces of the pressure-generating chambers 3 that serve as a plurality of individual liquid chambers or the selective supply paths 4 that communicate with these pressure-generating chambers 3 are formed by the slits formed on a duct plate 5. The selective supply paths 4 include large-diameter portions 4a whose sizes are relatively large in the plate-surface direction and small-diameter portions 4b (see FIG. 6) whose sizes are relatively small in the plate-surface direction, and the common chamber 10 that is a part of a fluid duct communicates with the pressure-generating chambers 3 separately through the selective supply paths 4. The amount of ink flowing from the common chamber 10 into the pressure-generating chamber 3 is controlled by the resistance at the small-diameter portion 4b.

Each of the pressure-generating chambers 3 communicates with one of the nozzle 2A formed on the nozzle plate 2. Slits are formed on the duct plate 5, which is an example of an individual liquid-chamber forming member or a selective supply-path forming member, by precision stamping, to form the selective supply paths 4 or the pressure-generating chambers 3.

On a vibration plate 8, for example, a diaphragm 7 that conveys the displacements of the piezoelectric actuator 21 to the pressure-generating chamber 3 in an efficient manner and a selective supply slot 6 that is arranged at the boundary between the common chamber 10 and the multiple selective supply paths 4 are formed. The diaphragm 7 is formed of a solid part of the base-material plate of the vibration plate 8, and has the same thickness as the base-material plate. The portion of the diaphragm plate 8 whose thickness is greater than that of the diaphragm 7 is made of the base-material plate and the portion of the base-material plate that is electroformed and electrodeposited. The inside of the selective supply path 4 communicates with the inside of the common chamber 10 through the selective supply slot 6.

A first frame 11 serves as a duct member, and a large rectangular through opening is formed thereon. This through opening makes up an actuator insertion portion 9 into which a piezoelectric actuator 21 as will be described later in detail is to be inserted. Similarly, a large rectangular opening that makes up the common chamber 10 is formed. A large rectangular opening 11a that makes up a temperature-control liquid duct 12, which is an example of a coolant duct, is also formed on a portion of the first frame 11 where the common chamber 10 is not formed. The temperature-control liquid duct 12 is formed so as to be adjacent to the common chamber 10, and is positioned across the common chamber 10 from the duct plate 5 where the pressure-generating chambers 3 are formed. In the present embodiment, the temperature-control liquid duct 12 is arranged above the common chamber 10 in the vertical direction.

A partition 13 covers the opening of the temperature-control liquid duct 12 in the first frame 11 to seal the temperature-control liquid duct 12. The partition 13 has through holes that are formed therethrough to make up ink ducts 14. The ink ducts 14 guide the ink sent from the head tank 102 to the common chamber 10, and discharge the ink that has passed through the common chamber 10 from the common chamber 10. The partition 13 also has through holes 13a that form temperature-control liquid ducts 15. Through the temperature-control liquid ducts 15, temperature-control liquid that is a coolant is fed to or discharged from the temperature-control liquid duct 12. For example, a cutting operation is conducted to form a through opening or through hole.

The through opening that has a rectangular shape and makes up the actuator insertion portion 9 is formed to accommodate the entirety of the piezoelectric actuator 21. However, no limitation is indicated thereby, and the through opening may be provided with a plurality of partition walls to increase the rigidity and accommodate a plurality of piezoelectric elements 19 of the piezoelectric actuator 21 separately. By increasing the rigidity, malfunctioning due to a mechanical factor of crosstalk or interference between channels, i.e., combinations of the nozzles 2A, the pressure-generating chambers 3, the selective supply paths 4, and the piezoelectric elements 19, can be reduced.

The piezoelectric actuator 21 includes a plurality of piezoelectric elements 19 each of which corresponds to one of the nozzles 2A, and a fixation member 20 to which the piezoelectric elements 19 are fixed. One end face of the piezoelectric element 19 is fixed to one end face of the fixation member 20 using an adhesive, and the other end face of the piezoelectric element 19 is bonded to the diaphragm 7. Each one of the piezoelectric elements 19 is connected to an individual electrode and a common electrode that is shared by all the elements, and the individual electrodes are connected to switching elements that individually control the turning on and off of the powers. Those switching elements are arranged on a flexible printed circuit board 22. With such an electrode arrangement, the piezoelectric elements 19 can be driven or displaced on an individual basis, and the pressure on the ink inside each one of the pressure-generating chambers 3 can be changed on an individual basis. Ink droplets are discharged from the nozzles 2A that communicate with the pressure-generating chambers 3 in which the pressure on the ink is increased by the displacement of the piezoelectric elements 19.

FIG. 6 is a lateral sectional view of the liquid discharge head 100 along line A-A′ in FIG. 3.

As illustrated in FIG. 6, the liquid discharge head 100 is provided with the head body 101, the head tank 102 that is an example of the first member, and a second frame 103 that is an example of a second member. The head tank 102 is a liquid storage in which liquid such as ink is stored.

The head tank 102 has an internal container space to contain ink. The second frame 103 makes up a part of the outer circumferential surface of the liquid discharge head 100.

For example, the head tank 102 is formed of resin material such as high-density polyethylene (PE), and the coefficient of linear expansion is set to a value equal to or greater than 10×10⁻⁵/K. The second frame 103 is formed of metallic material, and the coefficient of linear expansion is set to a value equal to or smaller than 2×10⁻⁵/K. The second frame 103 is formed of, for example, steel use stainless (SUS). By forming the head tank 102 of a resin material, the production cost of the head tank 102 can be reduced. However, no limitation is indicated thereby, and the head tank 102 may be formed of other materials.

The ink in the head tank 102 flows into the common chamber 10 through the ink duct 14. A large-diameter portion 4a of the selective supply path 4 of each channel communicates with the common chamber 10 through the selective supply slot 6. The ink that has entered the large-diameter portion 4a of the selective supply path 4 from the common chamber 10 enters the small-diameter portion 4b, and heads for the pressure-generating chamber 3 while being applied with resistance through the duct.

In the head body 101, the piezoelectric element liberates heat as the piezoelectric actuator 21 is driven to discharge ink. The heat generated by the piezoelectric element heats the ink to be ejected through a head structure such as the first frame 11 that makes up the head body 101. In order to discharge the ink at high speed, the piezoelectric actuator 21 has to be vibrated at high frequency. In particular, heat is liberated in such cases, and the temperature of the ink changes. The temperature of the ink may be changed by changes in the atmospheric temperature. Due to such changes in temperature, for example, the viscosity and surface tension of the ink change, and for example, the ink discharge speed or the discharge volume changes. As a result, the printing quality may be affected. Such an issue is applicable not only to piezoelectric methods as in the present embodiment but also to an electrostatic method or a method using a heating element in a similar manner.

A cooling structure that cools, for example, the components or ink inside the liquid discharge head is described below with reference to FIG. 7.

FIG. 7 is a sectional view of the liquid discharge head 100 along a line B-B′ in FIG. 6.

As illustrated in FIG. 7, the head tank 102 and the second frame 103 are fastened to each other by a screw 105. A contact surface C where the head tank 102 and the second frame 103 contact each other is illustrated in FIG. 7. In FIG. 7, the contact surface C is a planar portion parallel to the longitudinal direction. However, no limitation is intended thereby, and the contact surface C may be formed unevenly. For example, a sheet-like member may be interposed between the head tank 102 and the second frame 103, and the head tank 102 and the second frame 103 may be in indirect contact with each other. In such cases, the contact surface C is any surface of the interposed member.

A through hole 103a that makes up a part of the temperature-control liquid duct 12 is formed on the second frame 103. The through hole 103a communicates at one end thereof with the through hole 13a of the partition 13 and the opening 11a of the first frame 11. A through hole 102a is formed on the head tank 102. The other end of the through hole 103a of the second frame 103 communicates with the through hole 102a of the head tank 102.

A temperature-control duct 104 that is an example of a coolant-duct member is attached to the other end of the through hole 103a of the second frame 103 through the through hole 102a of the head tank 102. The temperature-control duct 104 is a hollow member having a substantially cylindrical shape and is formed of, for example, a metal material.

The temperature-control duct 104 is attached to the other end of the through hole 103a of the second frame 103, and thus the inner space 104a of the temperature-control duct 104 and the through hole 103a of the second frame 103 communicate with each other. Accordingly, a part of the temperature-control liquid duct 12 that continues through the inner space 104a, the through-hole 103a, the through-hole 13a, the opening 11a is formed. As described above, the temperature-control liquid duct 12 is a duct from the head tank 102 to the second frame 103, passes through the contact surface C. Directions D1 and D2 in which the temperature-control liquid is sent in the temperature-control liquid duct 12 are indicated by arrows in FIG. 7. The temperature-control liquid duct 12 is connected to an upstream portion of the inner space 104a and a downstream portion of the opening 11a, and forms a path that circulates in the liquid discharge head or the liquid ejection apparatus. The branch 12a that is a part of the temperature-control liquid duct 12 is adjacent to the common chamber 10 in the first frame 11, and extends in the longitudinal direction of the first frame 11. A pair of branches 12a are provided for each head body 101, and four branches 12a are arranged in total.

In the present embodiment, the temperature-control liquid is circulated inside the temperature-control liquid duct 12. Due to such a configuration, heat exchange is performed between the temperature-control liquid and the components arranged inside the liquid discharge head 100, and the liquid discharge head 100 can be cooled. Accordingly, a rise in temperature inside the liquid discharge head 100 due to, for example, the heat liberated from the above-described piezoelectric elements can be reduced. In particular, as illustrated in FIG. 6, the temperature-control liquid duct 12 is made adjacent to the common chamber 10 through which ink passes, and is formed so as to extend inside the first frame 11 in the longitudinal direction (see FIG. 5). Accordingly, the inside of the liquid discharge head can efficiently be cooled. In other words, the heat that is liberated from the piezoelectric elements is conveyed from the pressure-generating chamber 3 or the selective supply path 4 to the common chamber 10, and the ink inside the common chamber 10 is heated. In regard to the heat distribution of the entire ink in the head body 101, the temperature of the ink tends to be high at an upper portion of the common chamber 10 in the vertical direction due to the thermal convection. The head body 101 is arranged such that the nozzle plate 2 faces downward in the vertical direction, and liquid is discharged downward in the vertical direction. Accordingly, the temperature-control liquid duct 12 is arranged above the common chamber 10 in the vertical direction. Accordingly, the heat on the upper portion of the common chamber 10 in the vertical direction is heat-exchanged with the coolant in the temperature-control liquid duct 12, and the head body 101 with a high cooling efficiency can be implemented.

However, in the structure where the head tank 102 and the second frame 103 whose linear-expansion coefficients are different from each other are arranged in contact with each other as in the present embodiment, for example, the peeling off of one of the head tank 102 and the second frame 103 from the other, the peeling off of the ceiling, or cracking on some components may occur due to the differences in thermal contraction. In other words, when the head tank 102 is heated, the head tank 102 may greatly expand compared with the second frame 103. Due to such a configuration, for example, stress is applied between the head tank 102 and the second frame 103 when these members are cooled over time after heating and contract, and peeling or cracking occurs as described above. In particular, in the present embodiment, the head tank 102 that is made of resin contacts the second frame 103 that is made of metal, and feeding or discharging temperature-control liquid to the temperature-control liquid duct 12 is not sufficient to achieve a desired cooling due to a large difference in the coefficients of linear expansion.

By contrast, in the present embodiment, a temperature-control pool that is an example of a projecting part is arranged upstream and downstream from the contact surface C where the head tank 102 and the second frame 103 contact each other. More specifically, as illustrated in FIG. 7, the temperature-control duct 104 partially has a portion with a large diameter, and a first temperature-control pool 106 that is an example of a first projecting part is formed by the portion with a large diameter. The first temperature-control pool 106 is arranged inside the head tank 102. The first temperature-control pool 106 may be arranged outside the head tank 102 at a position adjacent to the head tank 102. The opening 11a of the first frame 11 has a portion extending in the direction reverse to the branch 12a, and this portion makes up a second temperature-control pool 107 that is an example of a second projecting part. In the temperature-control liquid duct 12, the first temperature-control pool 106 is arranged upstream from the contact surface C in the flowing direction of the temperature-control liquid, and the second temperature-control pool 107 is arranged downstream from the contact surface C in the flowing direction of the temperature-control liquid. However, no limitation is indicated thereby, and the temperature-control liquid may flow in the direction reverse to that in FIG. 7.

The temperature-control pool that is an example of a projecting part is a portion of the space that makes up the temperature-control liquid duct 12 that protrudes or expands in a direction different from the direction in which the temperature-control liquid is sent, in comparison to the other portions of the temperature-control liquid duct 12 such as the peripheral areas. For example, the first temperature-control pool 106 is a portion that protrudes in multiple directions on a plane perpendicular the direction D1 in which the temperature-control liquid is sent, and the second temperature-control pool 107 is a portion that protrudes in a direction reverse to the direction D2 in which the temperature-control liquid is sent. In other words, the second temperature-control pool 107 is a portion that protrudes in a direction different from the direction D1 in which the temperature-control liquid is sent. In the temperature-control liquid duct 12 provided with no temperature-control pool, the directions in which the temperature-control liquid is sent may be a direction where the temperature-control liquid flows along the duct, or may be a direction in which the temperature-control liquid duct 12 extends. When the temperature-control liquid duct 12 passes through the contact surface C at a plurality of positions, a temperature-control pool is arranged upstream and downstream from at least one of the positions at which the temperature-control liquid duct 12 passes through the contact surface C. More specifically, in the present embodiment, the first temperature-control pool 106 that is arranged upstream from the contact surface C is arranged inside or at a position adjacent to the head tank 102, and the second temperature-control pool 107 that is arranged downstream from the contact surface C is arranged inside the first frame 11. Alternatively, the second temperature-control pool 107 may be arranged more upstream from the first frame 11.

In the present embodiment, some temperature-control pools are arranged in the temperature-control liquid duct 12. Due to such a configuration, the flow of the temperature-control liquid inside the temperature-control liquid duct 12 is disturbed, and a turbulent flow occurs in the temperature-control pools. This allows the temperature-control liquid to stay in the temperature-control pools, and heat exchange between the temperature-control liquid and the components arranged inside the liquid discharge head 100 can be done more efficiently. More specifically, a turbulent flow of the temperature-control liquid occurs at each temperature-control pool arranged both upstream and downstream from the contact surface C across the contact surface C where stress occurs due to thermal contraction. Due to such a configuration, the stress on the contact surface C and areas around the contact surface C can be lightened, and the peeling off of one of the head tank 102 and the second frame 103 from the other, the peeling off of their ceilings, or cracking on those components can be prevented. In particular, the inside of the liquid discharge head can efficiently be cooled as the common chamber 10 is arranged and the second temperature-control pool 107 is arranged inside the first frame 11, which is arranged near the piezoelectric elements 19. Moreover, the head tank 102 can efficiently be cooled to prevent the thermal expansion of the head tank 102 as the first temperature-control pool 106 is arranged inside the head tank 102 of the temperature-control liquid duct 12 or at a position adjacent to the head tank 102.

In particular, when the difference in coefficient of linear expansion between the head tank 102 and the second frame 103 that contact with each other is large and equal to or greater than 8×10⁻⁵/K, it is desired that the configuration or structure of the liquid discharge heads 100 be applied in order to avoid the peeling or cracking as above.

In the present embodiment, a method of measuring a linear-expansion coefficient in accordance with, for example, “Measuring method of coefficient of linear thermal expansion of metallic materials” in Japanese Industrial Standards (JIS)-Z-2285 or “Testing method for linear thermal expansion coefficient of plastics by thermomechanical analysis” in JIS-K-7197 (2012) is adopted. A desired one of the measurement methods in JIS is adopted depending on the member to be measured.

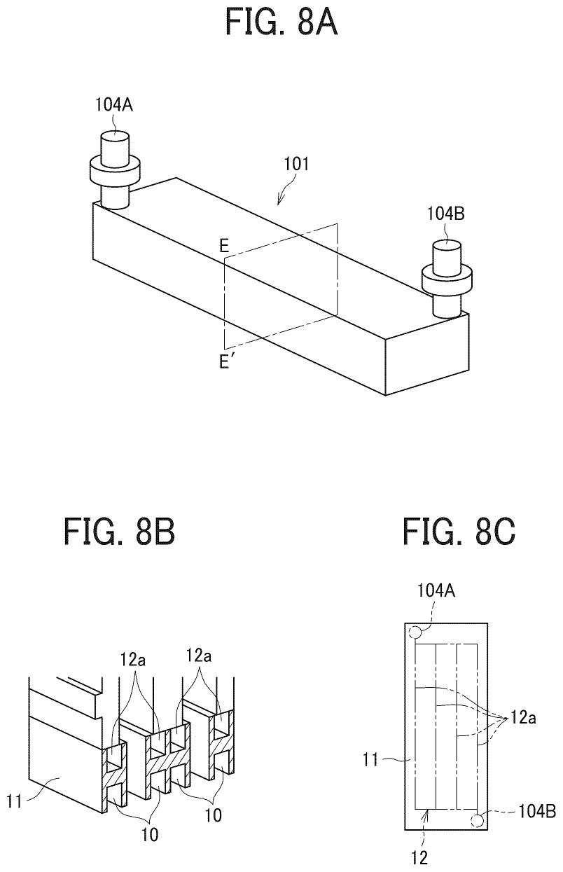

FIG. 8A, FIG. 8B, and FIG. 8C are diagrams illustrating an arrangement of the temperature-control liquid duct 12 in the first frame 11.

FIG. 8A is a perspective view of the liquid discharge head 100.

FIG. 8B is a sectional view of the liquid discharge head 100 along E-E′ in FIG. 8A.

FIG. 8C is a schematic plan view of the temperature-control liquid duct 12.

As illustrated in FIG. 8A, the temperature-control liquid duct 12 passes through areas inside the temperature-control ducts 104A and 104B at an entrance and exit of the first frame 11 in the liquid discharge head 100. In other words, the temperature-control ducts 104A and 104B make up an entrance and an exit for the first frame 11 of the temperature-control liquid duct 12.

As illustrated in FIG. 8B, the branches 12a of the temperature-control liquid duct 12 are arranged so as to be adjacent to the common chambers 10.

As illustrated in FIG. 8C, on a plane as illustrated in FIG. 8C perpendicular to the direction in which liquid is discharged from the nozzles, the temperature-control ducts 104A and 104B that make up an entrance and an exit for the first frame 11 of the temperature-control liquid duct 12 are located at diagonal positions with respect to the center position of the first frame 11. Accordingly, as illustrated in FIG. 8C, the temperature-control liquid duct 12 in the first frame 11 can be arranged in good balance. Accordingly, the temperatures in the first frame 11 or the liquid discharge head 100 are further uniformly distributed, and imbalanced stress inside the first frame 11 can be prevented. Accordingly, the peeling off of one of the head tank 102 and the second frame 103 from the other, the peeling off of their ceilings, and cracking on those components can be prevented. However, no limitation is indicated thereby, and it is not necessary for the temperature-control ducts 104A and 104B to be located at diagonal positions.

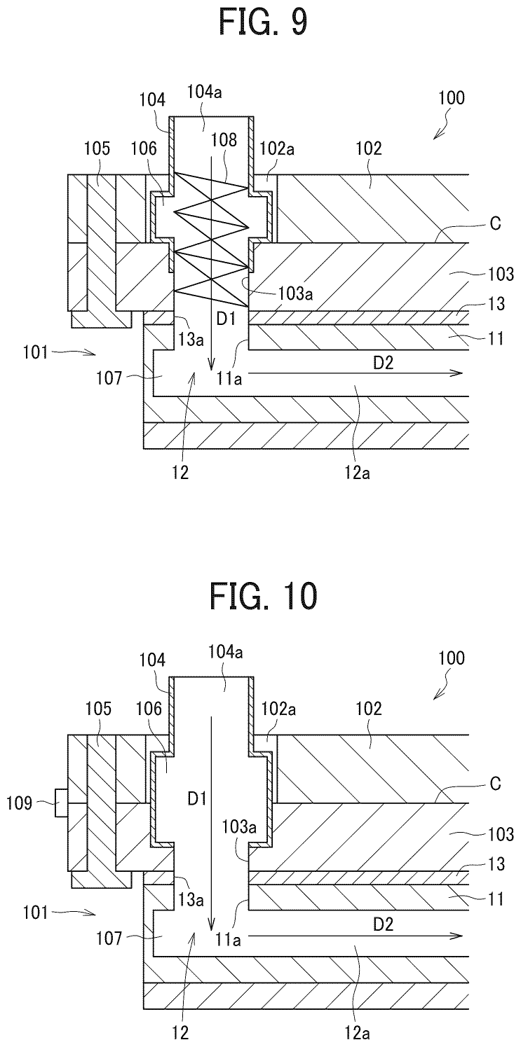

FIG. 9 is a sectional view of the liquid discharge head 100 according to a modification.

In the present embodiment described above with reference to FIG. 9, a resistance 108 is arranged inside the temperature-control liquid duct 12. The resistance 108 is arranged across the contact surface C, and is arranged in both the head tank 102 and the second frame 103. The resistance 108 is a static mixer. However, no limitation is indicated thereby, and the resistance 108 may be any member as long as it serves as a resistance to the flow of temperature-control liquid in the temperature-control liquid duct 12. For example, a long member having a mesh or slit may be disposed across the contact surface C in the vertical direction in FIG. 9. Providing the resistance 108 disturbs the flow of the temperature-control liquid inside the temperature-control liquid duct 12, and a turbulent flow occurs. As a result, the cooling efficiencies by the temperature-control liquid can be increased.

In particular, arranging the resistance 108 in both head tank 102 and the second frame 103 across the contact surface C enables the head tank 102 and the second frame 103 to be cooled efficiently. Accordingly, the peeling off of one of the head tank 102 and the second frame 103 from the other, the peeling off of their ceilings, and cracking on those components can further be prevented.

In the present embodiment described with reference to FIG. 10, the first temperature-control pool 106 that is a single unit is arranged across the contact surface C. In other words, the first temperature-control pool 106 is arranged across the head tank 102 and the second frame 103 that are arranged upstream and downstream from the contact surface C, respectively. Due to such a configuration, a turbulent flow is generated in the temperature-control liquid duct 12 especially near the contact surface C at which, for example, peeling or cracking occurs due to thermal contraction, and a greater cooling efficiency by the temperature-control liquid is achieved. Accordingly, the peeling or cracking as above can be prevented efficiently. As in the present embodiment, when a single temperature-control pool is arranged across a pair of components that are arranged upstream and downstream from the contact surface C, it is not necessary to arrange the second temperature-control pool. Note that it is more preferable to arrange the second temperature-control pool 107 because the first frame 11 provided with the common chamber 10 and the area around the first frame 11 can efficiently be cooled.

In the present embodiment described with reference to FIG. 10, an adhesive 109 that is an example of a coating is applied to the outer edge of the contact surface C where the head tank 102 and the second frame 103 contact each other. In the present embodiment, a metal adhesive is used as the coating. As a coating is arranged on the contact surface C, i.e., the boundary between the head tank 102 and the second frame 103, the adhesive 109 absorbs some of the heat around the contact surface C, and the temperature of the head tank 102 and the second frame 103 can be prevented from increasing. Accordingly, the peeling off of one of the head tank 102 and the second frame 103 from the other, the peeling off of their ceilings, and cracking on those components can further be prevented. However, no limitation is intended thereby, and the coating may be a sealant that seals the boundary between the head tank 102 and the second frame 103 or a coating that simply increases the thermal capacity.

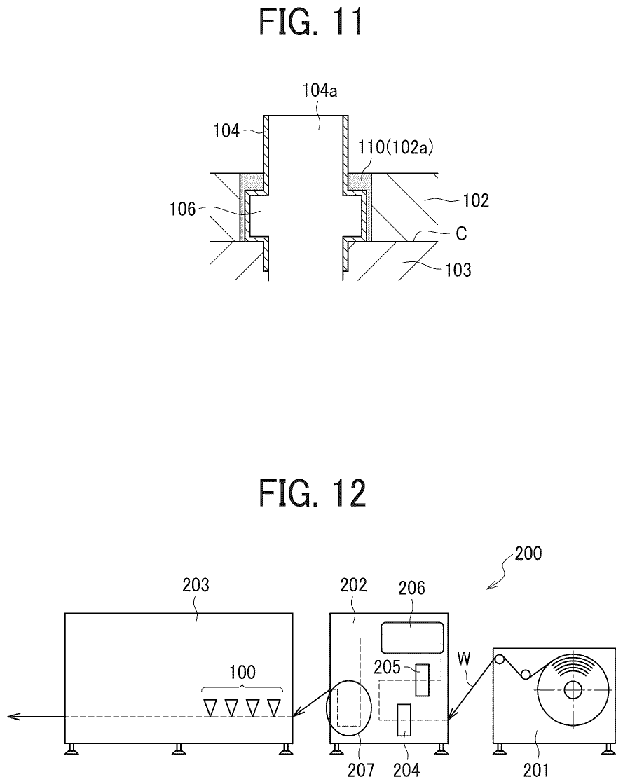

In the present embodiment described with reference to FIG. 11, the space between the head tank 102 and the temperature-control duct 104, which is the cavity of the through hole 102a, is filled with an adhesive 110 that is an example of the coating. Due to such a configuration, the adhesive 110 absorbs the heat of the head tank 102 in an efficient manner, and the temperature of the head tank 102 can be prevented from increasing. Accordingly, the peeling off of one of the head tank 102 and the second frame 103 from the other, the peeling off of their ceilings, and cracking on those components can further be prevented. The coating may be a sealant or coating that simply increases the thermal capacity.

It is desired that the adhesive 109 or the adhesive 110 be formed of, for example, a material whose thermal conductivity is higher than that of the head tank 102. Due to such a configuration, the adhesive 109 or the adhesive 110 absorbs the heat of, for example, the head tank 102 in an efficient manner.

In FIG. 10, both the adhesive 109 and the first temperature-control pool 106 arranged across the contact surface C are arranged. However, no limitation is intended thereby, and any desired combination may be adopted. For example, the adhesive 109 may be added to the arrangement described above with reference to FIG. 7, or the resistance 108 in FIG. 9 or the adhesive 110 in FIG. 11 may be combined with the arrangement described above with reference to FIG. 7.

FIG. 12 is a schematic diagram illustrating a structure of a liquid discharge apparatus 200 to which the above liquid discharge head 100 is applied.

The liquid discharge apparatus 200 in FIG. 12 discharges liquid to a web that is an example of a recording material.

As illustrated in FIG. 12, the liquid discharge apparatus 200 is provided with a sheet feeder 201, a pretreatment-liquid applying and drying device 202, and a printer 203. The sheet feeder 201 supplies a web W, which is a recording material such as a rolled long continuous form, to the pretreatment-liquid applying and drying device 202, which is arranged downstream from the sheet feeder 201 in the web conveyance path. The pretreatment-liquid applying and drying device 202 coats the web W with a pretreatment-liquid using a pretreatment-liquid applying unit composed of a pair of application units 204 and 205. The pretreatment liquid prevents bleeding or bleed-through of ink for inkjet printing that is printed onto the web W. After the application of the pretreatment liquid, the web W is dried by a drying device 206. A desired amount of buffer for the web W between the pretreatment-liquid applying and drying device 202 and the printer 203 is left by a dancer unit. In the printer 203, ink droplets are discharged onto at least one side of the web W to which pretreatment liquid has been applied in the pretreatment-liquid applying and drying device 202, to form an image as desired. The printer 203 is provided with first and second ink-jet printer units that discharge ink droplets onto both sides of the web W or a reversing unit. For the sake of explanatory convenience, in FIG. 12, only the liquid discharge heads 100 that discharge ink droplets to one side of the web W are illustrated. A post-drying device is arranged inside the printer 203 or at a downstream portion of the conveyance path in the printer 203. A winding device or a cutter device that cuts the web W and stacks the cut webs on top of each other may be arranged at a further downstream portion of the conveyance path in the printer 203. The directions indicated by arrows in FIG. 12 are directions in which the web W is sent, and directions in which a recording material is conveyed. Such directions also indicate the order of a series of liquid discharging steps or printing steps.

Any one of the above liquid discharge heads may be applied to the liquid discharge apparatus 200. Accordingly, the cooling efficiencies of the coolant duct can be increased. In the liquid discharge apparatus 200, the drying device 206 is arranged upstream from the liquid discharge heads 100 in the liquid discharging steps. Due to such a configuration, the temperature of the web W that is conveyed to the liquid discharge heads 100 tends to increase, and the temperature of the liquid discharge heads 100 also tends to increase. For this reason, it is desired that the liquid discharge heads 100 be applied to the liquid discharge apparatus 200.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

In the present disclosure, the liquid discharge apparatus includes a liquid discharge head or a liquid discharge unit, and drives the liquid discharge head to discharge liquid. The liquid discharge apparatus includes not only an apparatus that discharges liquid to an object to which liquid adheres but also an apparatus that discharges liquid into liquid or the air.

The liquid discharge apparatus may include means for feeding, conveying, or ejecting an object to which liquid adheres, or may include, for example, a pretreatment device and a post-processing apparatus.

The liquid discharge apparatus may be, for example, an inkjet recording apparatus that forms an image on a sheet by discharging ink, or a three-dimensional object forming apparatus that applies molding liquid to the powder layer made of layered granular materials so as to form a three-dimensional object.

The liquid discharge apparatus is not limited to an apparatus that uses the discharged liquid to visualize images with some meaning such as letters or figures. For example, the liquid discharge apparatus may be an apparatus that forms images with no meaning in themselves such as meaningless patterns or an apparatus that fabricates three-dimensional images.

The term “object to which liquid adheres” as above denotes, for example, an object to which liquid can at least temporarily adhere, an object to which liquid adheres and is fixed, and an object to which liquid adheres and permeates. Examples of the “object to which liquid adheres” include, but are not limited to, a recording medium such as a sheet of paper, a recording sheet, a film, and a cloth, an electronic component such as an electronic substrate or a piezoelectric element, and a medium such as a powder layer, an organ model, or a cell for testing. In other words, the “object to which liquid can adhere” may be any object to which liquid can adhere unless otherwise specified.

Examples of the “object to which liquid adheres” include any materials on which liquid can be adhered even temporarily, such as paper, thread, fiber, fabric, leather, metal, plastic, glass, wood, ceramic, construction materials (e.g., wallpaper or floor material), and cloth textile.

The term “liquid” may have any viscosity or surface tension as long as the liquid can be discharged from a liquid discharge head, and is not limited to any particular liquid. Preferably, such liquid to be discharged has a viscosity equal to or lower than 30 mPa·s at normal temperature and under normal atmospheric pressure or due to heating or cooling. Examples of the liquid include a solution, a suspension, or an emulsion that contains, for example, a solvent such as water and an organic solvent, a colorant such as dye and pigment, a functional material such as a polymerizable compound, a resin, and a surfactant, a biocompatible material such as deoxyribonucleic acid (DNA), amino acid, protein, and calcium, or an edible material such as a natural colorant. Such a solution, a suspension, and an emulsion are used for, e.g., inkjet ink, a surface treatment solution, a liquid for forming components of an electronic element and a light-emitting element or a resist pattern of an electronic circuit, or a material solution for three-dimensional fabrication. More specifically, the liquid may be, for example, ink, treatment liquid, deoxyribonucleic acid (DNA) sample, resist, pattern material, binder, molding liquid, or solution and dispersant including amino acids, proteins, or calcium.

The liquid discharge apparatus is an apparatus in which a liquid discharge head and an object to which liquid adheres moved relative to each other. However, no limitation is intended thereby. Examples of the liquid discharge apparatus include a serial device in which the liquid discharge head is moved and a line device in which the liquid discharge head is not moved.

Examples of the liquid discharge apparatus further include a treatment liquid coating apparatus to discharge a treatment liquid to a sheet to coat the treatment liquid on a sheet surface to reform the sheet surface and an injection granulation apparatus in which a composition liquid including raw materials dispersed in a solution is discharged through nozzles to granulate fine particles of the raw materials.

The liquid discharge unit is an integrated unit of the liquid discharge head, functional components, and mechanisms, and is a combination of parts related to liquid discharge. For example, the liquid discharge unit includes a combination of the liquid discharge head and at least one of a carriage, a supply unit, the maintenance-and-recovery unit, and a main-scanning movement unit.

In the present embodiment, examples of the single integrated unit include a combination in which the liquid discharge head and a functional component or a mechanism are secured to each other by, for example, fastening, bonding, and engaging, and a combination in which one of the liquid discharge head and a functional component or a mechanism is held by the other in a movable manner. The liquid discharge head may be detachably attached to the functional component or mechanism from each other.

The liquid discharge unit may be an integrated unit of the liquid discharge head and a carriage. The liquid discharge unit may be an integrated unit of the liquid discharge head and the main-scanning movement unit, where the liquid discharge head is movably held by a guide unit that configures a part of the main-scanning movement unit. The liquid discharge unit may be an integrated unit of the liquid discharge head, the carriage, and the main-scanning movement unit. The liquid discharge unit may be an integrated unit of the liquid discharge head, the carriage, and the maintenance-and-recovery unit, where a cap that configures a part of the maintenance-and-recovery unit is fixed to the carriage on which the liquid discharge head is mounted. The liquid discharge unit may be an integrated unit of the liquid discharge head and the supply unit, where a tube is connected to the liquid discharge head to which a head tank or a channel is attached. The main-scanning movement unit may be a guide unit alone. The supply unit may be a tube alone or a loader alone.

The terms “image formation,” “recording,” “printing,” “image printing,” and “fabricating” used herein can be used synonymously with each other.

Aspects of the present disclosure are, for example, as follows.

### First Aspect

A liquid discharge head includes a first member and a second member whose linear-expansion coefficients are different from each other, the first member and the second member disposed in contact with each other, and a coolant duct passing through an inside of the second member, where the coolant duct includes a first projecting part and a second projecting part, the first projecting part and the second projecting part project in a direction different from a direction in which a coolant is sent in the coolant duct, one of the first projecting part and the second projecting part is disposed upstream from a contact surface of the first member and the second member in the direction where the coolant is sent in the coolant duct, and the other one of the first projecting part and the second projecting part is disposed downstream from the contact surface in the direction where the coolant is sent in the coolant duct.

### Second Aspect

The liquid discharge head according to the first aspect, the first member and the second member have a difference in coefficient of linear expansion equal to or greater than 8×10⁻⁵/K.

### Third Aspect

In the liquid discharge head according to the second aspect, the first member is formed of a resin material whose coefficient of linear expansion is equal to or greater than 10×10⁻⁵/K, the first member is a liquid storage to store liquid discharged from the liquid discharge head, and the second member is formed of a material whose coefficient of linear expansion is equal to or smaller than 2×10⁻⁵/K.

### Fourth Aspect

The liquid discharge head according to any one of the first aspect to the third aspect further includes a resistance inside the coolant duct, where the resistance is disposed in both the first member and the second member across the contact surface, and the resistance disturbs a flow of the coolant.

### Fifth Aspect

In the liquid discharge head according to any one of the first aspect to the fourth aspect, the first projecting part or the second projecting part is disposed in both the first member and the second member across the contact surface.

### Sixth Aspect

In the liquid discharge head according to any one of the first aspect to the fifth aspect, the first member and the second member have a coating applied therebetween.

### Seventh Aspect

The liquid discharge head according to any one of the first aspect to the sixth aspect further includes a coolant-duct member forming a duct adjacent to the first member, the coolant-duct member is a part of the coolant duct, and the coolant-duct member and the first member have a gap filled with a coating.

### Eighth Aspect

The liquid discharge head according to any one of the first aspect to the seventh aspect further includes a discharge-orifice forming member having a plurality of discharge orifices through which liquid is discharged and a duct member including a fluid duct through which the liquid to be discharged passes and a part of the coolant duct, the coolant duct has an entrance to the duct member and an exit from the duct member, and the entrance and the exit are located at diagonal positions with respect to a center position of the duct member on a plane perpendicular to a direction in which the liquid is discharged from the plurality of discharge orifices.

### Ninth Aspect

A liquid discharge apparatus includes the liquid discharge head according to any one of the first aspect to the eighth aspect.

### Tenth Aspect

The liquid discharge apparatus according to the ninth aspect discharges liquid onto a recording material and further includes a drying device disposed upstream from the liquid discharge head in a conveyance direction of a recording material.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application-specific integrated circuit (ASIC), digital signal processor (DSP), field-programmable gate array (FPGA), and conventional circuit components arranged to perform the recited functions.

What is claimed is:

1. A liquid discharge head comprising:
a first member and a second member whose linear-expansion coefficients are different from each other, the first member and the second member disposed in contact with each other; and
a coolant duct passing through an inside of the second member, the coolant duct including a first projecting part and a second projecting part,
the first projecting part and the second projecting part projecting in a first direction different from a second direction in which a coolant is sent in the coolant duct,
one of the first projecting part and the second projecting part disposed upstream from a contact surface of the first member and the second member in the second direction, and
the other one of the first projecting part and the second projecting part disposed downstream from the contact surface in the second direction.

2. The liquid discharge head according to claim 1,
wherein the first member and the second member have a difference in coefficient of linear expansion equal to or greater than 8×10⁻⁵/K.

3. The liquid discharge head according to claim 2,
wherein the first member is formed of a resin material whose coefficient of linear expansion is equal to or greater than 10×10⁻⁵/K,
wherein the first member is a liquid storage to store liquid, and
wherein the second member is formed of a material whose coefficient of linear expansion is equal to or smaller than 2×10⁻⁵/K.

4. The liquid discharge head according to claim 1, further comprising
a resistance inside the coolant duct,
wherein the resistance is disposed in both the first member and the second member across the contact surface, and
wherein the resistance disturbs a flow of the coolant.

5. The liquid discharge head according to claim 1,
wherein the first projecting part or the second projecting part is disposed in both the first member and the second member across the contact surface.

6. The liquid discharge head according to claim 1,
wherein the first member and the second member have a coating applied therebetween.

7. The liquid discharge head according to claim 1, further comprising:
a coolant-duct member forming a duct adjacent to the first member,
wherein the coolant-duct member is a part of the coolant duct, and
wherein the coolant-duct member and the first member have a gap filled with a coating.

8. The liquid discharge head according to claim 1, further comprising:
a discharge-orifice forming member having a plurality of discharge orifices through which liquid is discharged; and
a duct member including a fluid duct through which the liquid to be discharged passes and a part of the coolant duct,
wherein the coolant duct has an entrance to the duct member and an exit from the duct member, and
wherein the entrance and the exit are located at diagonal positions with respect to a center position of the duct member on a plane perpendicular to a direction in which the liquid is discharged from the plurality of discharge orifices.

9. A liquid discharge apparatus comprising
the liquid discharge head according to claim 1.

10. The liquid discharge apparatus according to claim 9, further comprising
a drying device disposed upstream from the liquid discharge head in a conveyance direction of a recording material.
